(19) United States
(12) Patent Application Publication
(10) Pub. No.: US 2014/0359225 A1
(43) Pub. Date: Dec. 4, 2014

(54) MULTI-CORE PROCESSOR AND MULTI-CORE PROCESSOR SYSTEM

(71) Applicant: Electronics and Telecommunications Research Institute, Daejeon (KR)

(72) Inventor: Jae-Jin LEE, Daejeon (KR)

(73) Assignee: Electronics and Telecommunications Research Institute, Daejeon (KR)

(21) Appl. No.: 14/287,344

(22) Filed: May 27, 2014

(30) Foreign Application Priority Data
May 28, 2013 (KR) 10-2013-0060639

(51) Int. Cl. G06F 12/08

(52) U.S. Cl. CPC G06F 12/084; G06F 2212/6042
USPC 711/130

(57) ABSTRACT

Disclosed herein is a multi-core processor including: a plurality of processor cores; a shared data cache storing cache data previously accessed by at least one of the plurality of processor cores; and an address decoder comparing an address value of a data required by at least one of the plurality of processor cores and a set address register value with each other and allowing at least one of the plurality of processor cores to access the shared data cache or a separate memory in which non-cacheable data that are not stored in the shared data cache are stored.

### CROSS REFERENCE TO RELATED APPLICATION

This application claims the benefit of Korean Patent Application No. 10-2013-0060639, filed on May 28, 2013, entitled “Multi-core Processor and Multi-core Processor System”, which is hereby incorporated by reference in its entirety into this application.

### BACKGROUND OF THE INVENTION

1. Technical Field

The present invention relates to a multi-core processor and a multi-core processor system, and more particularly, to a multi-core processor and a multi-core processor system capable of easily performing parallel programming in a multi-core processor environment.

2. Description of the Related Art

A processor used in a smart phone has been currently evolved from a form of a single-core to a form of a dual-core, and will be evolved to a form of a multi-core of a quad-core or more in accordance with the trend toward development and miniaturization of the processor. Further, the next generation mobile terminal will use a multi-core processor in which several tens to several hundreds of cores are integrated to enable biometrics and augmented reality.

Up to now, performance of the processor has been improved by increasing a clock speed. However, when the clock speed is increased, power consumption and heat generation are increased. Therefore, it was no longer difficult to increase the clock speed.

Since the multi-core processor suggested as an alternative of the processor has several cores mounted therein, individual cores may be operated at a lower frequency, and power consumed in a single core is distributed to several cores. Since the multi-core processor has the same form as a form in which two or more central processing units are disposed, when a work is performed with a program supporting the multi-core processor, the work may be performed more rapidly as compared with a single-core processor, and the multi-core processor shows higher performance in works such as compression and reconstruction of a moving picture, a high specification game, and augmented reality in the next-generator mobile terminal that is based on multimedia processing, as compared with the single-core processor.

One of the most important elements in the multi-core processor is an efficient communication structure capable of supporting data levels and functional parallelization and decreasing a communication overhead between cores, while maintaining cache coherence.

A method of increasing work performance and decreasing a communication overhead by allowing cores to share data as much as possible with each other using a high performance and large capacity data cache has been suggested. This method is efficient in the case in which many cores share the same information as in a moving picture decoding application, but is inefficient in the case in which the respective cores use different information.

In addition, a method of efficiently performing parallel processing in a multi-processor environment by adjusting the number of processor allocated to an information consuming processor or an information allocation unit and appropriately limiting an access of a work memory used by the information consuming processor, based on a state of a sharing memory storing information shared by an information creating processor creating information and the information consuming processor consuming the created information has been suggested.

However, in this method, an additional hardware unit for monitoring the sharing memory and controlling the core is required, and performance may be deteriorated due to the limitation of the access of the sharing memory.

### SUMMARY OF THE INVENTION

An object of the present invention is to provide a multi-core processor and a multi-core processor system capable of improving performance of an application by supporting data levels and functional parallelization without implementing an additional hardware module for cache coherence causing deterioration of performance in a multi-core processor environment.

According to an exemplary embodiment of the present invention, there is provided a multi-core processor including: a plurality of processor cores; a shared data cache storing cache data previously accessed by at least one of the plurality of processor cores; and an address decoder comparing an address value of a data required by at least one of the plurality of processor cores and a set address register value with each other and allowing at least one of the plurality of processor cores to access the shared data cache or a separate memory in which non-cacheable data that are not stored in the shared data cache are stored.

According to another exemplary embodiment of the present invention, there is provided a multi-core processor system including: a plurality of clusters; and a memory including a cacheable area in which cacheable data supported in at least one of the plurality of clusters are stored and a non-cacheable area in which non-cacheable data different from the cacheable data are stored, wherein at least one of the plurality of clusters includes: a plurality of processor cores; a shared data cache storing cache data previously accessed by at least one of the plurality of processor cores; and an address decoder comparing an address value of a data required by at least one of the plurality of processor cores and a set address register value with each other and allowing at least one of the plurality of processor cores to access the shared data cache or the non-cacheable area.

### BRIEF DESCRIPTION OF THE DRAWINGS

FIG. 1 is a diagram schematically showing a multi-core processor system including a multi-core processor according to an exemplary embodiment of the present invention;

FIG. 2 is a block diagram showing a structure of a cluster shown in FIG. 1;

FIG. 3 is a block diagram showing a structure of an address decoder shown in FIG. 2; and

FIG. 4 is a diagram showing a memory map for communication between processors of the multi-core processor system according to an exemplary embodiment of the present invention.

### DESCRIPTION OF EXEMPLARY EMBODIMENTS

The following description illustrates only a principle of the present invention. Therefore, those skilled in the art may implement the principle of the present invention and invent various apparatuses included in the spirit and scope of the present invention although not clearly described or shown in the present specification. In addition, it is to be understood that all conditional terms and exemplary embodiments mentioned in the present specification are basically intended only to allow those skilled in the art to understand a concept of the present invention, and the present invention is not limited to exemplary embodiments and states particularly mentioned as such.

Further, it is to be understood that all detailed descriptions mentioning a specific exemplary embodiment of the present invention as well as principles, aspects, and exemplary embodiments of the present invention are intended to include structural and functional equivalences thereof. Further, it is to be understood that these equivalences include an equivalence that will be developed in the future as well as an equivalence that is current well-known, that is, all devices invented so as to perform the same function regardless of a structure.

Therefore, it is to be understood that, for example, a block diagram of the present specification shows an illustrative conceptual aspect for embodying a principle of the present invention. Similarly, it is to be understood that all flow charts, state transition diagrams, pseudo-codes, and the like, show various processes that may tangibly embodied in a computer-readable medium and that are executed by computers or processors regardless of whether or the computers or the processors are clearly shown.

Functions of various devices including processors or functional blocks represented as concepts similar to the processors and shown in the accompanying drawings may be provided by hardware having capability to execute appropriate software as well as dedicated hardware. When the functions are provided by the processors, they may be provided by a single dedicated processor, a single shared processor, or a plurality of individual processors, and some of them may be shared.

In addition, terms mentioned as a processor, a control, or a concept similar to the processor or the control should not be interpreted to exclusively cite hardware having capability to execute software, but should be interpreted to implicitly include digital signal processor (DSP) hardware and a read only memory (ROM), a random access memory (RAM), a non-volatile memory for storing software without being limited thereto. The above-mentioned terms may also include well-known other hardware.

In the claims of the present specification, components represented as means for performing functions mentioned in a detailed description are intended to include all methods for performing functions including all types of software including, for example, a combination of circuit devices performing these functions, firmware/micro codes, or the like, and are coupled to appropriate circuits for executing the software. It is to be understood that since functions provided by variously mentioned means are combined with each other and are combined with a scheme demanded by the claims in the inventions defined by the claims, any means capable of providing these functions are equivalent to means recognized from the present specification.

The above-mentioned objects, features, and advantages will become obvious from the following detailed description provided in relation to the accompanying drawings. Therefore, those skilled in the art to which the present invention pertains may easily practice a technical idea of the present invention. Further, in describing the present invention, in the case in which it is judged that a detailed description of a well-known technology associated with the present invention may unnecessarily make unclear the gist of the present invention, it will be omitted.

Hereinafter, exemplary embodiments of the present invention will be described in detail with reference to the accompanying drawings.

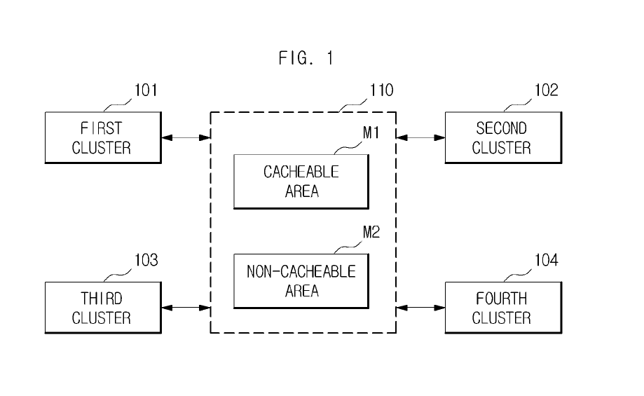

FIG. 1 is a diagram schematically showing a multi-core processor system including a multi-core processor according to an exemplary embodiment of the present invention.

Referring to FIG. 1, the multi-core processor system includes first to fourth clusters 101 to 104 and a memory 110.

In an exemplary embodiment of the present invention, the first to fourth clusters 101 to 104 are represented as four clusters. However, the number of clusters is not limited thereto.

In addition, although the case in which the first to fourth clusters 101 to 104 have the same structure is described, at least one of the first to fourth clusters 101 to 104 may have a structure different from those of the other clusters, but is not limited thereto.

Each of the first to fourth clusters 101 to 104 may process any application and perform data communication with other clusters.

The first to fourth clusters 101 to 104 may include at least two processor cores (not shown), a shared data cache (not shown), a shared instruction set cache (not shown), and an address decoder (not shown). A detailed description of these components will be described below.

The memory 110 may include a cacheable area M1 in which cacheable data supported in the first to fourth clusters 101 to 104 are stored and a non-cacheable area M2 in which non-cacheable data are stored.

Here, the cacheable area M1 may include address areas corresponding to the first to fourth clusters 101 to 104, respectively, and storing the cacheable data that may be stored in the shared data cache and the shared instruction set cache.

For example, the address areas may include a first address area in which a first instruction set and a first data supported in the first cluster 101 are stored, a second address area in which a second instruction set and a second data supported in the second cluster 102 are stored, a third address area in which a third instruction set and a third data supported in the third cluster 103 are stored, and a fourth address area in which a fourth instruction set and a fourth data supported in the fourth cluster 104 are stored, and the number of address areas may be changed depending on the number of clusters, but is not limited thereto.

In addition, at least one of the first to fourth instruction sets may be the same as each other and at least one of the first to fourth data may be the same as each other, but is not limited thereto.

The non-cacheable area M2 may include shared address areas shared by at least two of the first to fourth clusters 101 to 104, corresponding to the first to fourth clusters 101 to 104, respectively, and storing the non-cacheable data that may not be stored in the shared data cache and the shared instruction set cache.

For example, the shared address areas may include a first shared address area in which a first non-cacheable data shared by the first and second clusters 101 and 102 is stored, a second shared address area in which a second non-cacheable data shared by the second and third clusters 102 and 103 is stored, a third shared address area in which a third non-cacheable data shared by the third and fourth clusters 103 and 104 is stored, and a fourth shared address area in which a fourth non-cacheable data shared by the first and fourth clusters 101 and 104 is stored, and may include more shared address areas in a scheme as described above.

As described above, the non-cacheable area M2 may be an area that the first to fourth clusters 101 to 104 may directly access to perform loading/storing on the non-cacheable data.

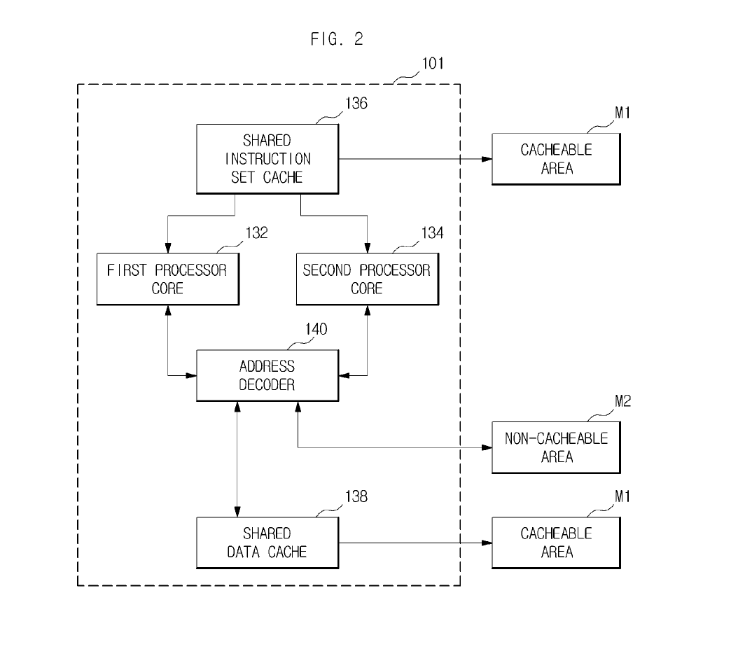

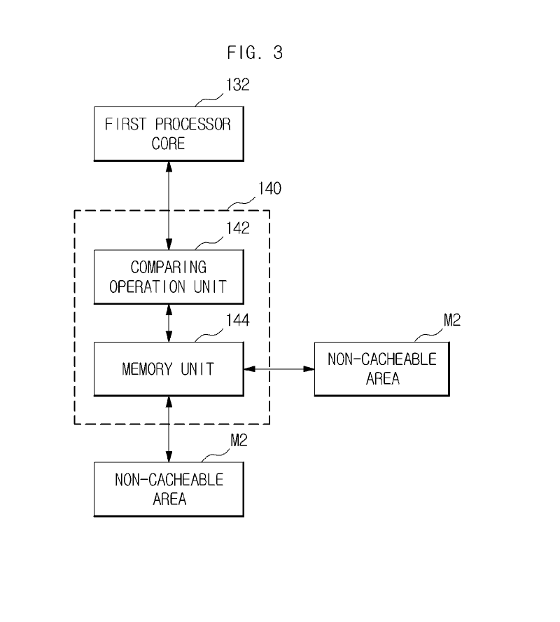

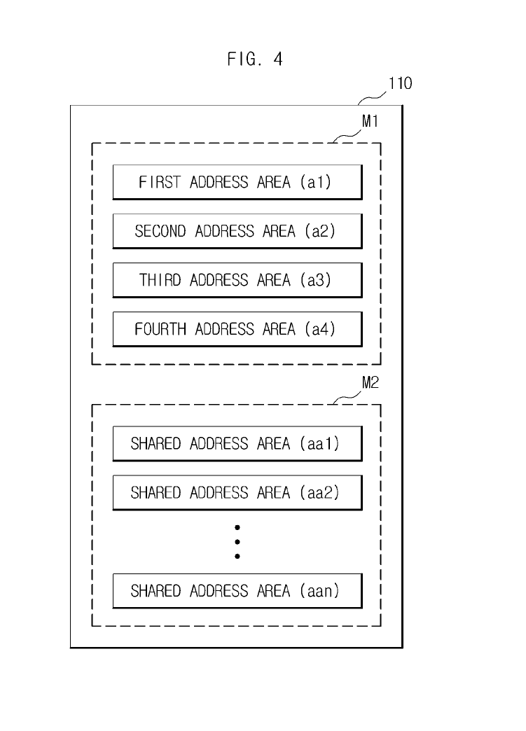

FIG. 2 is a block diagram showing a structure of a cluster shown in FIG. 1; FIG. 3 is a block diagram showing a structure of an address decoder shown in FIG. 2; and FIG. 4 is a diagram showing a memory map for communication between processors of the multi-core processor system according to an exemplary embodiment of the present invention.

In FIGS. 2 to 4, the first cluster 101 shown in FIG. 1 will be described, and the second and third clusters 102 and 103 may have the same structure as that of the first cluster 101 and may be operated in the same scheme as that of the first cluster 101, but are not limited thereto.

Referring to FIGS. 2 and 3, the first cluster 101 includes first and second processor cores 132 and 134, a shared instruction set cache (Shared I$) 136, a shared data cache (Shared D$) 138, and an address decoder 140.

Here, the first and second processor cores 132 and 134 may have an instruction set architecture and may perform operations using cache instruction sets and cache data stored in the shared instruction set cache 136 and the shared data cache 138.

The shared instruction set cache 136 stores the cache instruction sets accessed by the first and second processors 132 and 134 and accesses the cache instruction sets so that the first and second processors 132 and 134 perform the operations.

In addition, the shared data cache 138 stores the cache data accessed by the first and second processor cores 132 and 134 and allows the first and second processor cores 132 and 134 to access the stored cache data at the time of performing data communication between the first and second processor cores 132 and 134, thereby making it possible to maintain and improve cache coherence.

The address decoder 140 may compare an address value of a data required by at least one of the first and second processor cores 132 and 134 and a set address register value with each other and allow at least one of the first and second processor cores 132 and 134 to access the shared data cache 138 or the non-cacheable area M2 to access a corresponding data corresponding to the data.

Referring to FIG. 3, the address decoder 140 may include a comparing operation unit 142 comparing the address value and the address register value with each other and a memory unit 144 allowing at least one of the first and second processor cores 132 and 134 to access the shared data cache 138 when the address value is smaller than the address register value, as the comparison result of the comparing operation unit 142, and allowing at least one of the first and second processor cores 132 and 134 to access the non-cacheable area M2 when the address value is larger than the address register value, as the comparison result of the comparing operation unit 142.

For example, in the case in which the first processor core 132 of the first and second processor cores 132 and 134 requires the data, the comparing operation unit 142 compares the address register value of the first address area to and in which a first cacheable data supported in the first cluster 101 among the cacheable data required by the first processor core 132 in the cacheable area M1 is allocated and stored and the address value of the data with each other.

In this case, the memory unit 144 allows the first processor core 132 to access the shared data cache 138 or the non-cacheable area M2 depending on the comparison result of the comparing operation unit 142.

That is, the memory unit 144 allows the first processor core 132 to access the corresponding data corresponding to the data in the shared data cache 138 when the address value is smaller than the address register value and allows the first processor core 132 to access the corresponding data corresponding to the data in the non-cacheable area M2 when the address value is larger than the address register value.

In this case, the memory unit 144 may allow the first processor core 132 to access the corresponding data corresponding to the data in the non-cacheable area M2 to load/store the data.

The multi-core processor system according to an exemplary embodiment of the present invention is implemented using the cacheable data of the shared data cache or the non-cacheable data of the non-cacheable area while maintaining cache coherence at the time of performing data communication between different processor cores in the cluster.

In addition, the multi-core processor system according to an exemplary embodiment of the present invention may be implemented using the non-cacheable data of the non-cacheable area at the time of performing data communication between a plurality of clusters. In this case, since a memory access is required, performance deterioration may be generated. However, the multi-core processor system according to an exemplary embodiment of the present invention may generally maintain the cache coherence without implementing an additional hardware module.

Here, FIG. 4 shows a memory map of the memory 110.

That is, the memory 110 may include the cacheable area M1 including first to fourth address areas al to a4 to and in which the cacheable data including the instruction set and the data of each of the first to fourth clusters 101 and 104 are allocated and stored and the non-cacheable area M2 including a plurality of shared address areas aal to aan to and in which the non-cacheable data shared by at least two of the first to fourth clusters 101 to 104 are allocated and stored, as described above.

For example, in the case in which the memory 110 has a memory size of 16 MByte (0x000000−0xFFFFFF), a memory size of the cacheable area M1 may be 1 MByte (0x100000) in each of the first to fourth address areas a1 to a4, and a memory size of the non-cacheable area M2 may be 16 Kbyte (0x10000) in each of the plurality of shared address areas aa1 to aan.

Here, memory spaces corresponding to the cacheable area M1 and the non-cacheable area M2 may be changed depending on the number of clusters, but is not limited thereto.

The multi-core processor and the multi-core processor system according to an exemplary embodiment of the present invention support data and functional parallelization without implementing an additional hardware module for cache coherence in a multi-core processor environment, thereby making it possible to improve performance of an application.

In addition, the multi-core processor and the multi-core processor system according to an exemplary embodiment of the present invention may have extendability since they may be applied even in the case in which the number of processor cores is increased and may have generality since they may implement parallelization of various applications.

Although an exemplary embodiment of the present invention has been mainly described hereinabove, this is only an example and does not limit the present invention. Those skilled in the art to which the present invention pertains may understand that several modifications and applications that are not described in the present specification may be made without departing from the spirit of the present invention. For example, each component described in detail in an exemplary embodiment of the present invention may be modified. In addition, differences associated with these modifications and applications are to be interpreted as being included in the scope of the present invention as defined by the following claims.

What is claimed is:

1. A multi-core processor comprising:
a plurality of processor cores;
a shared data cache storing cache data previously accessed by at least one of the plurality of processor cores; and
an address decoder comparing an address value of a data required by at least one of the plurality of processor cores and a set address register value with each other and allowing at least one of the plurality of processor cores to access the shared data cache or a separate memory in which non-cacheable data that are not stored in the shared data cache are stored.

2. A multi-core processor system comprising:
a plurality of clusters; and
a memory including a cacheable area in which cacheable data supported in at least one of the plurality of clusters are stored and a non-cacheable area in which non-cacheable data different from the cacheable data are stored,
wherein at least one of the plurality of clusters includes:
a plurality of processor cores;
a shared data cache storing cache data previously accessed by at least one of the plurality of processor cores; and
an address decoder comparing an address value of a data required by at least one of the plurality of processor cores and a set address register value with each other and allowing at least one of the plurality of processor cores to access the shared data cache or the non-cacheable area.

3. The multi-core processor system of claim 2, wherein the cacheable area includes:
a first address area to and in which a first cacheable data supported in a first cluster of the plurality of clusters among the cacheable data is allocated and stored; and
a second address area to and in which a second cacheable data supported in a second cluster of the plurality of clusters among the cacheable data is allocated and stored.

4. The multi-core processor system of claim 2, wherein the non-cacheable area includes a shared address area storing the non-cacheable data shared by the plurality of clusters.

5. The multi-core processor system of claim 2, wherein the at least one cluster includes a shared instruction set cache storing cache instruction sets accessed by the plurality of processor cores among the cacheable data.

6. The multi-core processor system of claim 2, wherein the address decoder includes:
a comparing operation unit comparing the address value and the address register value with each other; and
a memory unit allowing at least one of the plurality of processor cores to access the shared data cache when the address value is smaller than the address register value, as the comparison result of the comparing operation unit, and allowing at least one of the plurality of processor cores to access the non-cacheable area when the address value is larger than the address register value, as the comparison result of the comparing operation unit.

7. The multi-core processor system of claim 6, wherein the cacheable area includes a first address area to and in which a first cacheable data supported in a first cluster of the plurality of clusters among the cacheable data is allocated and stored and a second address area to and in which a second cacheable data supported in a second cluster of the plurality of clusters among the cacheable data is allocated and stored, and
the comparing operation unit compares the address register value corresponding to the first address area and the address value with each other.

8. The multi-core processor system of claim 6, wherein the memory unit allows at least one of the plurality of processor cores to access a cache data corresponding to the data among the cache data stored in the shared data cache when the address value is smaller than the address register value.

9. The multi-core processor system of claim 6, wherein the memory unit allows at least one of the plurality of processor cores to access a non-cacheable data corresponding to the data among the non-cacheable data stored in the non-cacheable area when the address value is larger than the address register value.

10. The multi-core processor system of claim 2, wherein any cluster of the plurality of clusters accesses a shared data cache included in another cluster of the plurality of clusters.
